(19) United States
(12) Patent Application Publication
(10) Pub. No.: US 2004/0210452 A1
(43) Pub. Date: Oct. 21, 2004

(54) Method and system for unifying and sharing of business systems

(76) Inventors: Roger B. Aboujaoude, Ocean Township, NJ (US); Hossein Eslambolchi, Los Altos Hills, CA (US); Saeid Shariati, Annandale, NJ (US); Robert Joseph Sloan, Westfield, NJ (US)

Correspondence Address: AT&T CORP., P.O. BOX 4110, MIDDLETOWN, NJ, 07748, US

(21) Appl. No.: 10/757,556

(22) Filed: Jan. 14, 2004

Related U.S. Application Data
(60) Provisional application No. 60/439,910, filed on Jan. 14, 2003.
(60) Provisional application No. 60/490,142, filed on Jul. 24, 2003.
(60) Provisional application No. 60/490,682, filed on Jul. 28, 2003.

(51) Int. Cl. G06F 17/60

(52) U.S. Cl. 705/1

(57) ABSTRACT

A method and system for unifying and sharing business applications with respect to a user of a business channel. The method and system include authenticating and authorizing, at a unified portal, user preferences and restrictions in response to a user request for access. An enterprise function provides a common customer identifier (CCI) for users associated with a plurality of business channels, wherein the enterprise function associates a CCI to the user accessing the unified portal. In response to a user selection of a business application, information associated with a plurality of business applications is integrated across products and services, where the integrated business applications are responsive to authorized user selections of at least one business application from the portal. Information associated with the business channels, each user, and the products and services is stored at a virtual database warehouse for retrieval by said business applications upon request of the user.

### CROSS-REFERENCE TO RELATED APPLICATIONS

This application claims benefit of U.S. provisional patent application serial No. 60/439,910, filed Jan. 14, 2003, which is incorporated by reference herein in its entirety.

### FIELD OF THE INVENTION

The present invention relates generally to a system and method for unifying and sharing business systems, and more specifically, for unifying and sharing business applications and systems associated with various channels of a telecommunications service provider.

### BACKGROUND OF THE INVENTION

Telecommunication carriers provide many services for their customers and each of these services require the involvement of many heterogeneous systems to provision such services. Specifically, telecommunication carriers have telecommunication networks that connect and manage the services provided to their customers' networks. For example, telecommunication carriers provide various services, such as voice grade communication channels for their customers' local private branch exchange (PBX), IP services, frame relay services, nodal services, among many other services.

Various types of channels are associated with a telecommunications carrier to support the products and services provided by the carrier. Typical channels illustratively include a sales channel, a customer channel, an alliance channel, an internal operations channel, among other channels that functionally exist to support and provide services for a business entity, such as a telecommunications carrier. Typically, each of the channels has its own distinct systems/processes and databases for providing the functional aspects of the channel in order to support the products and services provided by the carrier.

In particular, to support the channels, many existing heterogeneous telecommunications systems exist today that manage customer-to-carrier interaction. These heterogeneous telecommunications systems typically include many ordering systems, trouble reporting (maintenance) systems, alarm systems, billing systems, provisioning systems, and the like, all of which have respective services associated therewith. Many of these systems and services are isolated from each other, thereby requiring the channel user to separately log into each of these systems (i.e., access points) to make inquiries and retrieve information. Accordingly, many of the applications associated with the systems of each channel are “silo-driven” applications, meaning that the business processes (e.g., billing, and ordering) associated with one channel is isolated from those of other channels.

For example, an enterprise having various divisions and/or subsidiaries may be included in the customer channel of the carrier. Each division/subsidiary has its own independent business applications (e.g., billing, ordering, and the like) associated with the carrier. As such, channel users in one division have no or limited knowledge of the business practices with the carrier for the other divisions/subsidiaries. Thus, each division/subsidiary has no or limited knowledge of the impact to the other divisions/subsidiaries, or the enterprise as a whole, that may be caused by the business practices of the other division/subsidiary.

From the perspective of the customer, the customer is typically unable to scrutinize the impact of changing one type of service as such change relates to other services the customer is or could receive. For example, a division (or subsidiary) of an enterprise may need to change (e.g., increase) its network capacity. Customer pricing is typically dependent on the amount of business (i.e., revenues) the customer is giving to the carrier. Accordingly, pricing for such changes may be afforded greater discounting if the purchasers for the enterprise are able to access all of the customer business given to the carrier as an enterprise entity, as opposed to just a division/subsidiary placing an order. That is, it is desirable for the purchaser of services to be able to leverage the overall business of the enterprise (as opposed to, illustratively, a division) against the carrier to realize greater savings.

From the perspective of the carrier, over time, associated services offered through these systems, have become complex, such that it becomes extremely difficult for a telecommunication carrier salesperson (i.e., persons in the sales channel) to be aware of all the services that could be offered to a customer. For that matter, it has become even more difficult to determine which services best fit the particular needs of the customer.

Therefore, there is a need for a method and system for unifying and sharing business systems to provide improved customer control of network management activities. Such unified and shared business systems should reflect the customer's business policies and procedures, in addition to the customer's optimization routines, the customer's network designs, services ordered, billing, provisioning, and inventory control, as well as provide a common access point having a particular look and feel.

### SUMMARY OF THE INVENTION

The disadvantages heretofore associated with the prior art are overcome by the present invention of a method and system for unifying and sharing business applications with respect to a user of a business channel. The method and system include authenticating and authorizing, at a unified portal, user preferences and restrictions in response to a user request for access. An enterprise function provides a common customer identifier (CCI) for users associated with a plurality of business channels of an enterprise, wherein the enterprise function associates a CCI to the user accessing the unified portal. Furthermore, the CCI is associated with at least one master customer number (MCN) which identifies business sub-entities of an enterprise customer.

In response to a user selection of a business application, information associated with a plurality of business applications is integrated with respect to products and services. The integrated business applications are responsive to authorized user selections of at least one business application from the unified portal. Information associated with the business channels,. each user, and the products and services is stored at a virtual database warehouse based on the MCNs of the enterprise customer, and the information may be retrieved by the business applications upon request of the user based on the user preferences and restrictions.

### BRIEF DESCRIPTION OF THE DRAWINGS

The teachings of the present invention can be readily understood by considering the following detailed description in conjunction with the accompanying drawings, in which:

FIG. 1 depicts a block diagram illustrating functional aspects of a business entity having a unified shared system of the present invention;

FIG. 2 depicts a schematic diagram of an exemplary network in which the present invention may be advantageously employed;

FIG. 3 depicts a block diagram illustrating functional software components of directory enabled network services application of the unified shared system;

FIG. 4 depicts a flow diagram of integrated business applications interface of the unified shared system for providing cross-channel services associated with various business applications and products;

FIG. 5 depicts a block diagram of a virtual data warehouse of the unified shared system; and

FIGS. 6A and 6B collectively depict a flow diagram of a method for retrieving information associated with functional aspects of a business operation in accordance with the present invention.

To facilitate understanding, identical reference numerals have been used, when appropriate, to designate identical elements that are common to the figures.

### DETAILED DESCRIPTION OF THE PREFERRED EMBODIMENT

The present invention includes a system and method for unifying and sharing business systems. Specifically, the present invention provides an access point enabling users of various channels associated with a service provider (e.g., telecommunications carrier) to access and perform one or more functional aspects associated with business processes (e.g., ordering, inventory, billing, maintenance, provisioning, among others), depending on a predefined user profile. Access to the various business processes and functional aspects associated therewith are provided from a single access point, where each business process has a similar look and feel, thereby enabling the user to experience a sense of accessing multiple functional aspects of its business in the same manner, as opposed to having to access different access points having dissimilar interfaces.

Specifically, the present invention provides a method and system for providing a unified and shared access point to selectively retrieve information and perform tasks associated with various business functions of a service provider. The unified and shared business system of the present invention is illustratively discussed in terms of a service provider such as a telecommunications carrier, however, one skilled in the art will recognize that the service provider may be any business entity that provides products (i.e., goods and/or services) of any kind to various enterprise customers, whether it is for profit or non-profit purposes. The method integrates a plurality of user parameters (e.g., user preferences and restrictions), as well as integrates a plurality of business processes associated with the user. For example, a user having a particular user profile associated with a high-level officer of an enterprise (e.g., a conglomerate) may access and initiate processes related to multiple business applications across many subsidiaries of that business, such as ordering, maintenance, payment, sales, billing, among other business applications (i.e., business functions) from a single access point, in order to make inquiries and/or view particular information of concern to the requester.

A customer utilizing the present invention may access the information from various types of devices and locations to place an order, make billing inquiries, and/or the like, depending on the user profile of such user. For example, a user may access the access point through a web site access point (e.g., portal) from his/her desktop, by making a voice tone telephone call, among other vantage points. Thus, the present invention is tailored for each user affiliated with a particular channel to provide access to and perform various functions and operations of business, illustratively conducted with a telecommunications service provider.

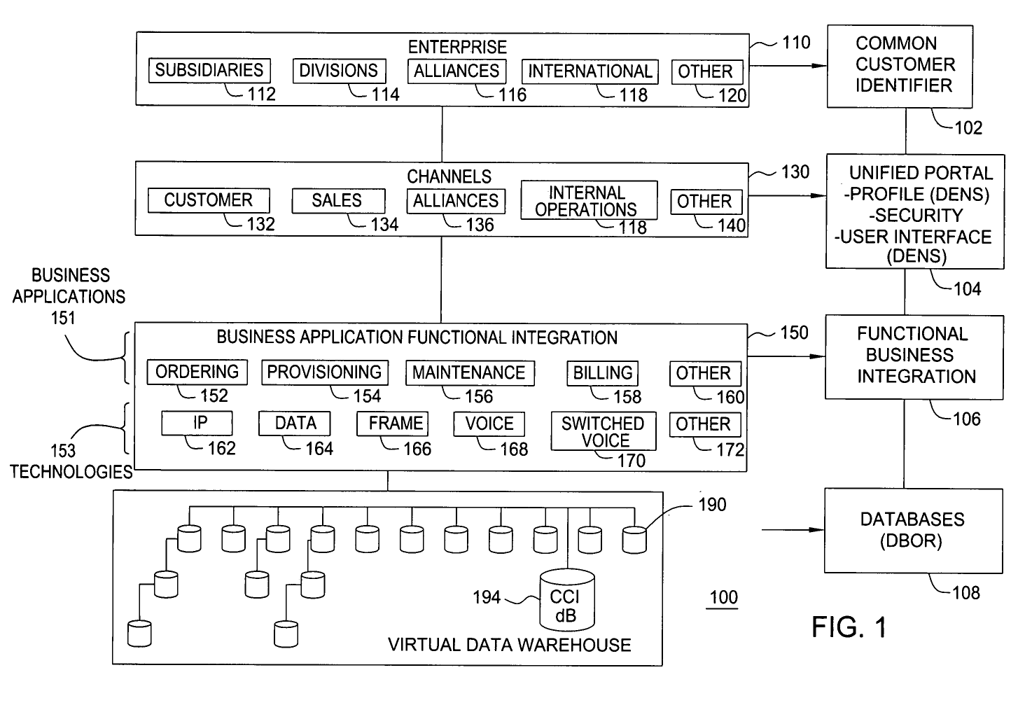

FIG. 1 depicts a block diagram illustrating functional aspects of a business entity having a unified shared system 100 of the present invention. The unified shared system 100 of the exemplary telecommunications service provider (hereinafter “carrier”) comprises and enterprise function 110, a plurality of channels 130, business application functional integration 150, and a virtual data warehouse 190. The enterprise function 110 correlates enterprise customer business entities by a common customer identifier (CCI) 102. For example, the divisions/subsidiaries of a particular enterprise customer are all assigned the same CCI, thereby associating each division, subsidiary, alliance or other business sub-entity with a single enterprise customer.

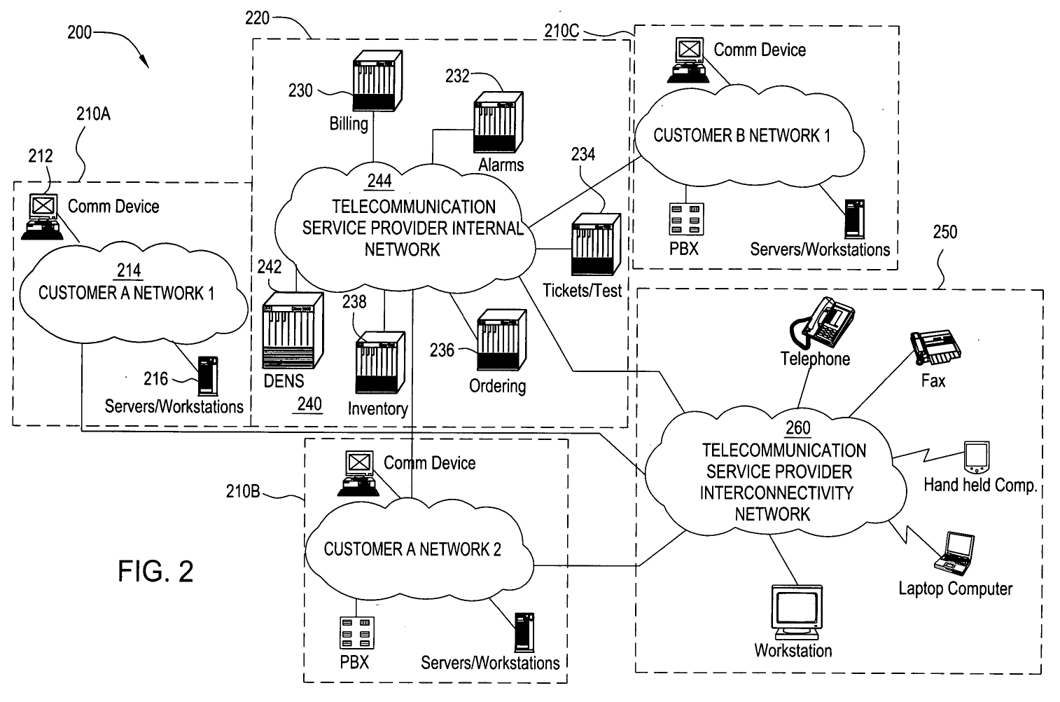

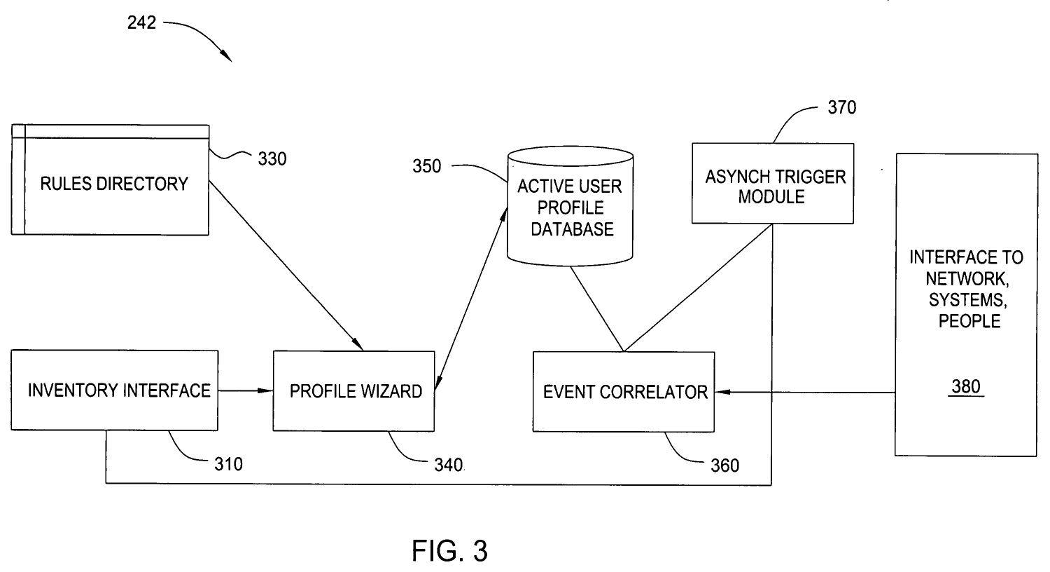

Users associated with the various channels 130 of the carrier may access the unified shared business system 100 of the present invention by accessing a unified portal, (e.g., a website) based on profile and authentication information associated with the user. Specifically, a user profile is created for each user in the channels of the carrier. The user profile contains rules of engagement of how the telecommunication carrier shall operate on behalf of the user for a particular customer, as discussed below with respect to FIGS. 2 and 3.

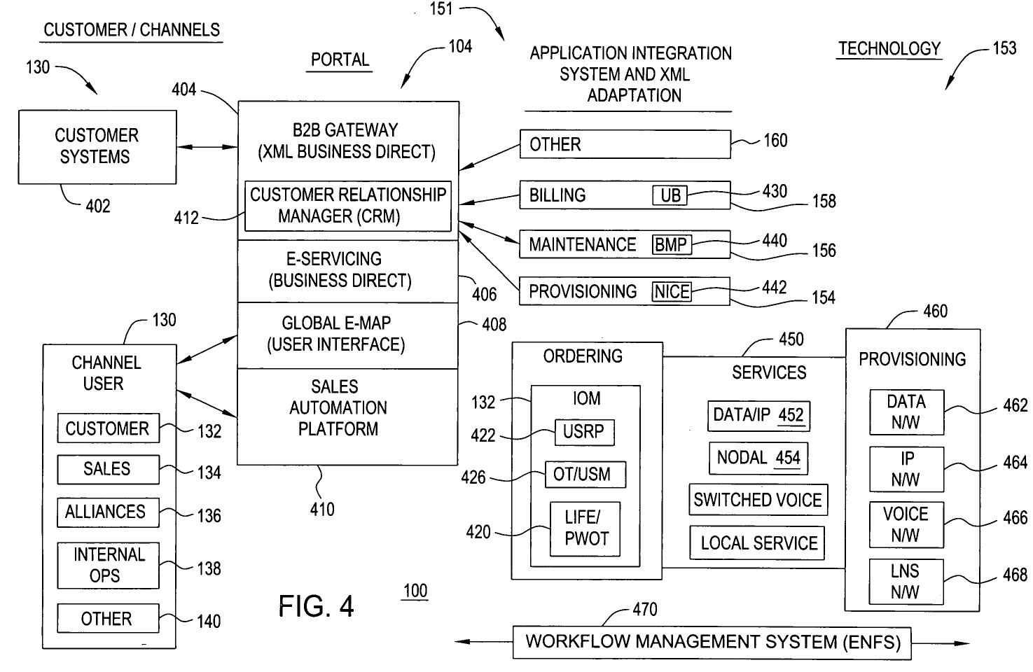

In particular, the unified shared system 100 of the present invention allows users associated 151 with each channel to selectively employ various business applications such as ordering, provisioning, maintenance, billing, among other business applications 151 with respect to various technologies 153, which include goods and services offered by the carrier. For example, an authorized user in a division of an enterprise customer (i.e., customer channel 132) may wish to place an order to a particular technology, such as switched voice 170 services. In this instance, an integrated order manager (IOM) 132 serves as a single point-of-contact interface directly between the customer and the various service offerings (e.g., IOM), as discussed below with respect to FIG. 4.

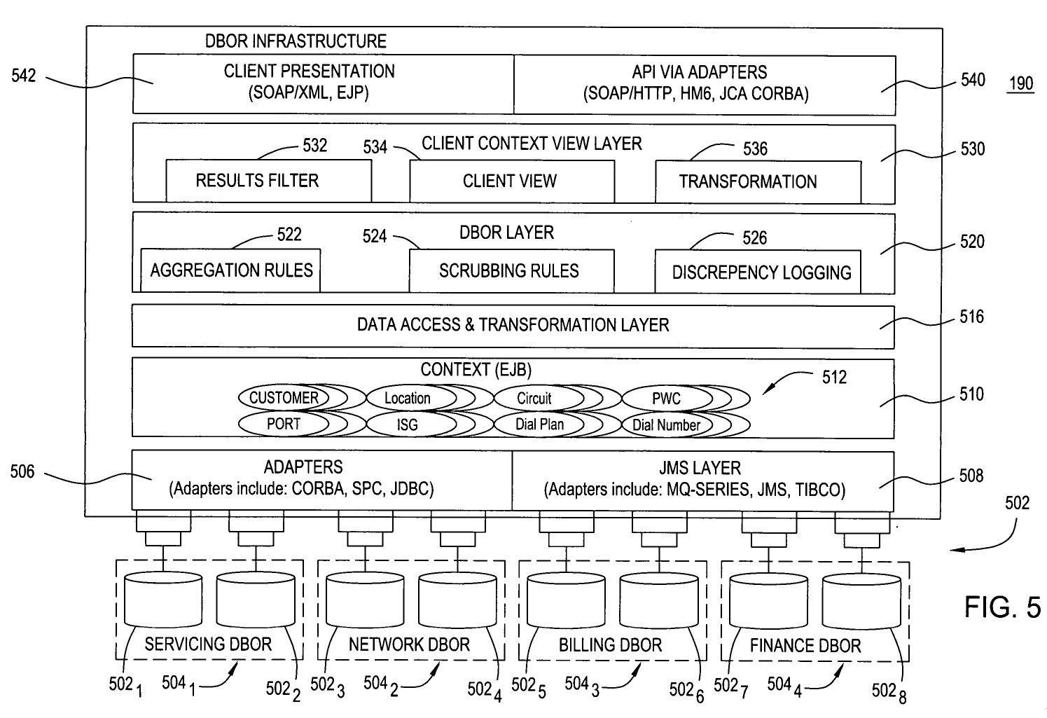

The virtual data warehouse 190 stores all of the information associated with the enterprise functions 110, channels 130 and channel users, and the business applications 151 and technologies 153, such as product types, inventory, among other information. The virtual data warehouse 190 serves as a data repository, and more particularly as a centralized customer database with respect to billing, service, and network information such as used by front-end client applications catering to customer needs, as discussed below with respect to FIG. 5.

Referring to FIG. 1, the plurality of channels 130 may include customer channels 132, sales channels 134, alliance channels 136, internal operations (non-sales) channels 138, among other channels 140 associated with the business entity (i.e., the telecommunications service provider). In particular, the sales channel 134 represents sales and support persons associated with sales of goods and services of the exemplary carrier. The alliance channel 136 represents those sales and support persons associated with business entities outside of the carrier business entity, such as licensees, product and service vendors, and the like. The customer channel 132 relates to the customers of the carrier who purchase the goods and/or services the carrier provides. For example, the customers of a carrier typically include various business entities (e.g., corporations, partnerships, among others) and consumers (i.e., residential customers) in various markets.

The internal non-sales channel 138 includes those persons associated with the carrier 100 that are not affiliated with the sales channel 134. For example, the non-sales channel 138 may include factory workers, maintenance personal, engineering personnel, among any other business disciplines not associated with the sales channel 134. It is noted that the channels 130 shown in FIG. 1 may include any other conventionally known business related channel 130, and such depicted channels should not be considered as limiting.

The enterprise function 110 is associated with the customer channel 132, but may be utilized by users associated with any of the other channels 130. The enterprise function 110 associates various business sub-entities of the customer, such as subsidiaries 112, divisions 114, alliances 116, international businesses 118, or other affiliations 120 of a customer in terms of a unified business entity. For example, a conglomerate (e.g., General Electric (GE) Corporation) has numerous business entities that together form and define the conglomerate (i.e., enterprise) as a whole.

Each customer is provided with a common customer identifier (e.g., a number) 102. For single entity customers, such as residential subscribers for services, a single CCI is associated to each individual residential customer. Similarly, a single CCI is associated with all of the subsidiaries, divisions, alliances, international business, and the like for each enterprise customer. Accordingly, each division, subsidiary, and the like of an enterprise share a common customer identifier. The common customer identifier 102 of the enterprise function 130 may be utilized by users associated with any of the channels 130 to selectively retrieve information and/or perform various business applications associated with their channels 130. For example, an internal sales representative associated with the sales channel 134 of the carrier may utilize the CCI to place an order for some technology (i.e., service and/or goods) for a customer.

The common customer identifier (CCI) is created as a database of record for the carrier, and is stored in the virtual data warehouse 190 along with other customer related information. The CCI is utilized to track customers who do business with the carrier and potential customers. The CCI manages relationships between customers, their agreements with the carrier, and their remit level account identifiers. This information allows the carrier to establish legal ownership of agreements and accounts, as well as understand relationships that cross legal boundaries, such as accounts that are owned by one customer but purchase services from another customer's agreement. In one embodiment, the enterprise function associates the legal entities of an enterprise customer based on the Dun and Bradstreet (D&B) registry, and is capable of provisioning a CCI for those customers and enterprise customers that are not enrolled with D&B.

The enterprise function 110 is capable of creating, maintaining, and updating changes to the customer's enterprise, including customer locations and contact information; identifying and updating mergers and acquisitions of customer holdings; track spin-off's of customer holdings, which entails split or creation of a new contract for the services rendered by a service provider; integrating with other data management systems, such as Customer Financial Management (CFM) and Customer Relationship Management (CRM), to track the customer, accounts, services delivery and assurance; identifying and tracking the credit worthiness of a customer and associated customer holdings; as well as providing the ability for a carrier to provide promotions or preferential treatments for the customers.

The business application functional integration 150 integrates various business applications 151 across different technologies, services and products 153. The business applications include ordering 152, provisioning 154, maintenance 156, billing 158, among other business applications 160 as conventionally known in the art. For example, the ordering application 152 allows a user associated with a particular channel to place an order for services, check on inventory, generate reports, and the like across all services, technologies, and products (e.g., including bundled products/services). The maintenance application 154 allows a user to illustratively generate trouble tickets, maintenance reports, and the like. Similar business functions are associated with the provisioning, billing, and other business applications of the carrier.

The technologies 153 of the carrier include various way products and services provided to the customers by the carrier. For example, a business entity such as a telecommunications carrier illustratively provides internet services (IP) 162, data 164, frame/ATM networks 166, voice 168, switched voice 170, among other technologies 172, including a combination thereof for its customers.

As briefly discussed above, the channels 130 include persons associated with sales channels, customers, alliances, internal non-sales persons, among other channels. For example, a service provider, such as AT&T Corp. of Bedminster, N.J., provides various services associated with each customer channel (e.g., an enterprise), which may illustratively include wireless and wired communications, virtual private networks, voice tone services, interactive voice response services, among many other communication services. Users affiliated with one or more customer channels may wish to access the service provider to place an order, perform billing inquiries, and initiate repair tickets, among other functional aspects of various business processes. As discussed below in further detail, each user accessing the access point has a predetermined user profile that enables the user to access certain functional aspects of the business processes, as well as retrieve related information, while also prohibiting access to other channel users who have different profile data.

FIG. 2 depicts a schematic diagram of an exemplary network 200 in which the present invention may be advantageously employed. Specifically, FIG. 2 illustrates an exemplary network 200 having customer networks 210A-210C (collected customer networks 210), a telecommunication service provider's operations and maintenance network 220, and a facilities network 250 designed to carry voice and data traffic over a customer's network intra/interstructures. The customer networks 210A-210C typically include business customers, which contract for services such as asynchronous transfer mode (ATM), frame relay services, nodal services, virtual private network (VPN), voice circuit services, disaster recovery services, soft disconnect, and the like from the telecommunications service provider. Those of ordinary skill in the art will appreciate that the exemplary network 200 depicted in FIG. 2 is provided solely for illustrative purposes, and is not meant to imply architectural limitations with respect to the present invention.

Although multiple customer networks 210 are shown in FIG. 1, customer network 210A may be considered as representative of other customer networks shown in FIG. 2. Customer network 210A may include a server/workstation 116 that represents one or more servers, workstations, and other network devices, as well as a communication device 212 that represents a mobile or land line telephone, pager, fax machine, palm computer, and the like. The server/workstation 216 and communication device 212 may connect to the customer network 200 through wire or wireless connections 214. Customer network 210A may be implementing IP services from the telecommunication service provider, while customer network 210B may be implementing private branch exchange (PBX) trunk services in support of the customer's resident PBX. It is noted that the customers may have multiple heterogeneous networks, such as exemplary customer A, which subscribes to IP services for network 210A and PBX support services for network 210B.

The facilities network 250 includes the interconnectivity network 260 and a variety of exemplary communication devices such as telephones, facsimiles, hand-held computers, lap-top computers, workstations, among other communication devices. Depending on the subscribed service, facilities network 250 may represent an ATM wide area network, a public switched telephone network (PSTN), a high speed internet protocol (IP), and the like.

The operations and maintenance network 220 provides services and management of those services to customers. The operations and maintenance network 220 illustratively includes server 230, 232, 234, 236, 238, and 240, which are connected together over a server provided Internet network 244. It is noted that although FIG. 2 shows applications running on individual servers 230, 232, 234, 236, 238, and 240, each application may be distributed to operate on a group of networked computers as well.

In particular, server 230 operates billing applications, which illustratively tracks the accrued customer costs of subscribed services and issues bills to subscribed customers. Server 232 operates alarm applications, which track and report occurrences of alarms affecting subscribed services within facilities network 260, as well as the interfaces between a customer network 210 and the telecommunication service provider network 244. Server 234 operates trouble reporting and test applications, which allow customers to report problems with subscribed services and tract resolution of those reported problems. Additionally, the trouble reporting and test applications enable the customers to test subscribed circuits.

Server 236 operates ordering applications, which allow customers to add, remove, and modify offered telecommunication services. An ordering application receives an order request and distributes the necessary work requests to complete such order request. Server 238 operates inventory applications, which track customer's subscribed services on one customer network or across multiple customer networks that may span geographical locations. The inventory application also stores a history of services purchased by a customer.

Server 240 operates a directory enable network services (DENS) application (function) 242, which provides a three phase approach to managing subscribed services relative to customer needs to define a customer relationship. The first phase includes interviewing the customer about a particular service being offered. In one embodiment, the interview is driven by a dynamic decision tree. After completing the interview, a master customer profile is created based on the interview responses. The master customer profile is considered to be in an active state in instances where it contains instructions to take actions upon the occurrence of events generated by the operations and maintenance network 220 or the facilities network 230 on behalf of the customer, without involving the direct attention of the customer. The master customer profile acts as a proxy on behalf of the customer and provides the customer access to private telecommunication carrier systems such as billing, ordering, inventory, and the like according to the rules defined within the master customer profile. The proxy ensures limited and secure access to the private systems. The second phase includes monitoring for the occurrence of events. The third phase includes performing an associated action in response to an event received by the DENS application 242.

FIG. 3 depicts a block diagram illustrating functional software components of the directory enabled network services application 242 of the present invention. The DENS application 242 includes an inventory interface 310, a rules directory 330, a profile wizard 340, an active user profile database 350, an event correlator 360, an asynchronous trigger module 370, and a network interface 380 which includes interfaces to systems such as AT&T's integrated order manager, e-maintenance, an alarm viewer, and a flow through management system.

During an interview with a customer, the customer using a web browser, for example, accesses the profile wizard 340 through a business portal interface such as AT&T BusinessDirect®. For example, the customer may logon on to the ATT BusinessDirect® application over the Internet. The business portal interface forwards a uniform resource locator (URL) representing the server location of the profile wizard 340 to the customer's web browser over existing IP protocols. The profile wizard 340 interviews the customer on a per service basis by prompting the customer with questions and receiving answers from the customer. The profile wizard 340 determines customer tailored questions by accessing historical information concerning the customer, accessing the customer's subscribed services through the inventory interface 310, and retrieving applicable questions from the rules directory 330 based on the historical and other learned customer information and responses provided by the customer on previously asked questions. Historical information may include information gathered from previous interactions between the customer and the telecommunication carrier. The rules directory 330 is typically stored on permanent storage such as a disk and written to random access memory (RAM) during application runtime for quick access.

The wizard constructs the questions from rules in the rules directory and asks the customers only those questions that pertain to their specific situation. Examples of questions include: Would you like to perform soft or hard disconnect when you decide to disconnect service? Would you like to upgrade existing locations that have more than 8 DS0s to a T1.5? Would you allow DS0 orders that put your DS0 group over 8 DS0s per location, or would you like to convert the orders to T1.5? Do you want AT&T to upgrade your permanent virtual circuits (PVC) which have been operating at data rates that exceed committed information rate (CIR)? Do you want AT&T to detect virus conditions using traffic signatures and alert you to the sources of virus-like traffic?

After completing the interview with the customer, the profile wizard 340 writes an active master profile into the user profile database 350. The active master profile dictates the communication with the customer and may contain actions to perform in response to events received. The specific actions and events are determined by the customer responses gathered for each individual service to which an interview was conducted. An example of an active master profile is shown in FIG. 4 and described further below. The event correlator 360 periodically reads the user profile database 350 to determine whether an event should be processed by the DENS application 242 for the specific customer. The event correlator 360 filters duplicate or inconsequential events which may arise because of lack of interest in the profile as well as network conditions such as alarms due to failure of interdependent technologies.

The network interface 380 may include software interfaces to system software operating the managed network 130, the maintenance and operations network 120, and/or software applications. The network interface 380 provides access to the DENS application 242 for receiving events and executing actions. In addition to generating events due to a networks state, the system software also supports manual entry of events by telecommunication operators or customers. When an event is received by the event correlator 360 through the network interface 380, the event correlator 360 determines whether the received event should be filtered or further processed. If it is, the event is sent to the asynchronous trigger module 370 where it extracts the master customer number (MCN) from the event. The asynchronous trigger module 370 retrieves an associated active master profile by issuing a database query containing the MCN on the user profile database 350. The asynchronous trigger module 370 reads the active master profile to determine if the received event in combination with optional predetermined conditions in the master profile is satisfied to result in performing or causing to perform the associated action. If conditions are satisfied, the asynchronous trigger module 370 executes the associated action stored in the active master profile. Depending on the action, the asynchronous trigger module 370 causes the performance of the action by issuing calls through network interface 380 or the inventory interface 310.

The profile wizard 340, the event correlator 360, the asynchronous trigger module 370, and the interfaces 310 and 380 are implemented in software and are executed by the processor in the computer 140. For example, a customer may have multiple networks such as one in Raleigh, another in Cincinnati, and another in San Jose. That customer may want to define rules of engagement, which will apply when any of the customer's local network operators need to modify the services which are provided by their telecommunication carrier. For example, the customer may want to impose many requirements on the customer's local network operators when modifying or ordering voice circuits. One requirement may include automatically upgrading a committed information rate (CIR), if the permanent virtual circuit (PVC) traffic rate exceeds the CIR. A second requirement may include satisfying a condition before issuing an action such as analyzing the customer's current service inventory. For example, if a customer requests a new DS0 and after the DENS system 242 analyzes the number of DS0s to which the customer currently subscribes, the customer may require that any new DS0 requests that exceed the total of DS0s within a trunk group over a threshold such as 8 DS0s would automatically change to a request to order a T1.5 and to convert the existing DS0s into channels to be carried over the newly ordered T1.5. A third requirement may include sending an email or page to the customer's telecommunications/information technology director every time a network operator orders a new T1.5 trunk. A fourth requirement may include specifying the default settings for elements required when ordering a new service. A fifth requirement may include requiring AT&T to provide virus alerts and protection using a traffic signature.

It is recognized that a customer may have many more requirements to be defined by the rules of engagement between the customer and the telecommunications service provider. For example, a customer may require that a periodic report be run on the inventory of services being subscribed to determine if the voice and data circuits can be combined between the different customer sites to achieve cost savings and that an analysis on all of the customer sites be run to determine if they all have disaster recovery options (DRO) specified. The customer may want any of the customer's sites that don't subscribe to DRO at the same level as utilized by the most protected site.

To ensure that the customer rules of engagement are satisfied, the customer interacts with the DENS system 242 to create an active master profile, also referred to as a proxy, to operate on the customer's behalf on each order transaction or event without the customer's direct involvement on each element of the transaction. Returning to the example, the customer first logs on to a business portal such as ATT BusinessDirect®. The customer may access the business portal through various means including the Internet, an interactive voice response (IVR) unit, or other suitable medium. The business portal invokes the profile wizard 340. The profile wizard 340 communicates with the rules directory 330 and an inventory interface 310 to determine a dynamic decision tree tailored for the customer. Through the inventory interface 310, the profile wizard 340 determines that the customer has three locations and the inventory of services includes frame, asynchronous transfer mode (ATM), IP, and switched voice, for example. The inventory interface 310 allows the profile wizard 340 to collect data from many heterogeneous telecommunication systems such as an enterprise wide inventory system like AT&T's Database of Record (DBOR) 190. Based on the information gathered through the inventory interface, the profile wizard 340 constructs a decision tree containing questions used to interview the customer. It is noted that there are two levels of dynamic decision tree construction. The first level includes determining a set of questions and their content relevant to the customer. The second level includes presenting a question from the set of relevant questions depending on the customer's response to previously presented questions and the current state of learned information gathered about the customer.

Each decision branch illustrates the question progression to ask the logged on customer. By the DENS application 242 analyzing the customer's inventory, the DENS application 242 knows that the customer subscribes to DS0s, PVCs, and IP services. As a result, the profile wizard 340 constructs a decision tree, as conventionally known in the art. The profile wizard 340 tracks each selection made by the customer. After all the selections are made, the profile wizard 340 creates a master profile for this customer storing events, actions, and optional conditions. The profile wizard 340 stores the master profile into the user profile database 350. Thus, the DENS application 242 provides a unified portal for all channel users of the carrier, as well as generates, stores, and updates a user profile associated with each user. Accordingly, the DENS application 242 enables a user to access particular business processes and services, based on the user's user profile.

Thus, the enterprise function 110 associates the business processes (i.e., various accounts) across all of the divisions/subsidiaries of an enterprise entity. For example, a purchasing manager of a division may wish to see how much business is being conducted with their telecommunications service provider. Pricing may be discounted based on yearly amounts spent by the business, such that purchasing discounts may increase as certain dollar amounts spent or volume of business is given to the telecommunications service provider by the division/subsidiary. The enterprising function allows such purchasing manager to investigate and quantify the total amount of business given to the telecommunications service provider by the enterprise, as opposed to just the division/subsidiary itself. In this manner, the purchasing manager may leverage the business of the entire enterprise to negotiate better pricing or services.

In one embodiment, the enterprise function 110 is a feature that is enabled for all individuals utilizing the unified shared system 100 of the present invention. However, the enterprising function 110 may be tailored to provide limited access to other business processes 151 and functions based on the user's user profile. For example, the purchasing manager illustratively discussed above may utilize the enterprise function 110 to receive purchasing information, but will be denied access to other business processes of the enterprise, such as maintenance, finance, among other enterprise business processes not related to his/her job description (e.g., outside of the scope of purchasing or various purchasing related functions).

Referring to FIG. 1, the business application functional integration 150 provides automated and integrated management systems for various business applications 151 by providing a single interface between the customer and the business applications and services of the exemplary carrier. The business applications 151 illustratively comprise ordering 152, provisioning 154, maintenance 156, billing 158, among other business applications 160. Each business application 151 is associated with a particular product (i.e., technology) such as IP, data, voice, switched voice, local network services (LNS), among other technologies provided by the carrier.

FIG. 4 depicts a flow diagram of integrated business applications interface 150 of the unified shared system 100 for providing cross-channel services associated with various business applications and products. Customer systems 402 may be coupled to the unified portal system 104 of the unified shared system 100 illustratively via the internet to provide customer channel access to the unified shared system 100. As discussed above, the users are associated with various channels, such as the customer channel 132, sales channel 134, alliances 136, international operations 138, among other channels 140 associated with the carrier.

The portal 104 is the point of entry into the unified system. The user accesses the portal through the Internet or through IVR (voice tone). The portal 104 is a host that allows other applications to be run, such as DENS, IOM, e-map (which is a user interface that provides two or three-dimensional graphical representations of data to the user illustratively at the website), among others. The portal requests authentication data (user ID and password) from the user. The authentication data is sent to the DENS application 242 to authenticate the user and identify his/her capabilities and preferences. It is noted that the DENS user profile is created and updated during previous sessions with the unified shared system 100 via the portal.

The user is associated with a CCI number that is stored in a CCI database 194 of the DBOR 190. The CCI number is used to identify a user with a particular enterprise. That is, from the perspective of the user, the CCI defines the enterprise “universe” that the user is associated (i.e., the user's association with an enterprise or a division/subsidiary of that enterprise). Additionally, from the perspective of the carrier, the CCI provides indicia service (e.g., preferential service) for an enterprise customer.

It is noted that in one embodiment, the CCI database 194 is created using may other databases, such as the commercially known Dun & Bradstreet databases. The CCI is a number that is related to many other numbers known as master customer numbers (MCN), which represent certain subsidiaries/divisions, sub business entities of the enterprise customer. For example, General Electric Corp. may illustratively have a CCI value of 100, where MCN 100.01 identifies GE Capital, MCN 100.02 identifies GE Aircraft, 100.23 identifies NBC, and so on.

In particular, the user logs into the portal, and is welcomed by the DENS application 242 to provide authentication information. It is assumed that the users profile information was previously established during prior sessions and stored in the DBOR 190. Once the user is authenticated by DENS application 242, the DENS application 242 sends the CCI to the CCI database 194, where the CCI database 194 provides the DENS application 242 the most recent information regarding the subsidiaries/divisions, accounts, contracts, and the like associated with that CCI number.

The DENS application 242 then utilizes the information to determine the carrier/enterprise relationship. For example, in one embodiment, DENS 242 may determine enterprise customer priority levels, based on revenues, volume of business, longevity of customer relationship, among other factors. In other words, the DENS function uses the CCI to determine the types and quantity of business the enterprise and service provider (i.e., carrier) transact with each other. The priority levels may be used by the carrier to provide greater levels of service for those enterprise customers that have higher priority ratings.

The DENS application 242 also uses the CCI number to determine how much informational access such user has within that enterprise based on the pre-established user profile. For example, a senior officer may be provided access to all subsidiaries of the enterprise. By comparison, a maintenance person in one of the subsidiaries of the same enterprise would only be provided access to maintenance related information for that particular subsidiary, to illustratively generate a trouble ticket.

The portal 104 hosts the DENS application 242, as discussed above. The portal also hosts the integrated functional applications 420, 430, 440 to provide a gateway (e.g., business-to-business (B2B) gateway) 404 to access the integrated functional applications 420, 430, 440 such as ordering, billing and so forth, through a machine to machine interface, as discussed above. The portal 104 further comprises various user interfaces, such as textual 406, graphical (global e-map 408), or machine to machine (B2Bi XML Gateway).

The integrated applications system 151 serves as an interface between the channel users and the services 450 to be provisioned. As discussed above, the integrated applications system 151 comprises ordering 152, provisioning 154, maintenance 156, billing 158, and other business related functions 151. Each business application 151 comprises a manager to interact between the portal 104 and the technologies to be provisioned 460.

The integrated business application interface 150 is illustratively discussed in terms of an integrated order management (IOM) system 132, however the teachings discussed herein are also applicable to the other business applications 151 (e.g., provisioning, billing, maintenance, and the like). For example, the billing application functionality 158 comprises a universal biller (UB) 430 for customer billing, the maintenance application functionality 156 comprises a business maintenance platform (BMP) 440, and the provisioning application functionality 154 comprises a network inventory and servicing environment (NISE) platform 442.

As discussed above, the exemplary carrier provides various services 450, such as data/IP 452, nodal 454, switched voice 456, local service 458, among other services. For example, the inclusion of the IOM 132 in the ordering process 152 allows for a customer to order services online, change existing services, view location level inventory for change/delete orders, disconnect service, order new services, add new locations, and/or establish billing groups, among other options and across all these technologies and services.

When the user identifies themselves via the portal, the DENS application 242 sends the CCI value of the enterprise customer to the CCI, where the CCI returns all of the MCNs associated with the enterprise customer. The MCNs are used to retrieve the data from the DBOR 108, since the data is stored separately for each of the individual subsidiaries/divisions of the enterprise, as opposed to being stored for the entire enterprise as under a single identifier. Thus, the CCI is associated with all transactions being performed through the system, such as the IOM application.

Referring to FIG. 4, the exemplary IOM 132 is positioned to receive input service requests from any one of the various channel sources, such as the customers, sales executives, or any other type of service contract negotiator. The IOM 132 then illustratively interacts either with the data/IP USRP 422 for data/IP services 452, order taker/universal service manager (OT/USM) 424 for long distance voice 456, or local service order platform/prime web order taker (LIFE/PWOT) 426 for local services 458. Each of these platforms 422, 424, 426 interacts directly with the provisioning network managers to provide such services. For example, the USRP 422 interacts with a data provisioning manager 462 or IP provisioning manager 464 for provisioning data/IP services 452. Similarly, the OT/USM 424 interacts with the voice provisioning manager 466 for switched voice services 456, and the LIFE/PWOT 426 interacts with the local network services (LNS) manager 468 for local services 458. In further accordance with the present invention, an end-to-end flow thru management system (EFMS) 470 and the provisioning manager (NISE) 442 interact with the IOM 132 via the USRP 422, OT/USM 424, LIFE/PWOT 426, among other service ordering managers, as well as each service, to monitor the progress of each order as it is placed.

In one embodiment, the IOM 132 is particularly useful in that the IOM includes linkages to downstream systems, such as a product catalog, account manager, billing account profile, the universal biller 430, a customer financial manager, among other downstream systems to deliver necessary data to facilitate flow-through from the input requests (e.g., customer or sales reps) to the provisioning operations 460. It should be noted that the teachings of the IOM 132 are applicable to the other business application functions 151, such as provisioning 154, maintenance 156, billing 158, among the other integrated business applications 160. For a detailed understanding of the IOM, the reader is directed to U.S. patent application Ser. No. 10/672,041, filed Sep. 25, 2003 (Attorney Dkt. No. Aboujaoude 2002-0278), which is incorporated by reference herein in its entirety.

Thus, the user uses the portal to access one of the hosted applications, such as IOM, e-match, e-map, and the like. The portal then passes the authentication data and CCI information to the selected application. For example, the IOM uses the CCI number to get the MCNs, and then extracts the customer inventory from the DBOR 108 to assist the customer in performing a change (e.g., addition or deletion action) on their existing inventory. Furthermore, the CCI may be utilized to assign preferences to various customers of the carrier, illustratively based on customer size or segment of the market.

FIG. 5 depicts a block diagram of a virtual data warehouse 190 of the unified shared system 100. The virtual data warehouse 190, termed a database of records (DBOR), comprises a plurality of storage devices 502. As shown in FIG. 5, the storage devices 502 are grouped according to function 504, such as servicing 504₁, networking 504₂, billing 504₃, finance 504₄, among other functional aspects of the business entity (e.g., carrier). Each functional database group 504 typically comprises a primary storage device and a secondary (backup) storage device. For example, the servicing DBOR 504₁ illustratively includes a primary storage device 502₁ and a secondary storage device 502₂. Similarly, the network DBOR 504₂ illustratively includes a primary storage device 502₃ and a secondary storage device 502₄, the billing DBOR 504₃ illustratively includes a primary storage device 502₅ and a secondary storage device 502₆, so forth, where each of the primary and secondary storage devices may represent a single or multiple (e.g. one or more arrays) of storage devices connected in any conventionally known configuration.

It is noted that the DBOR 190 stores enterprise information related to the type of business the service provider (e.g., carrier) provides for its enterprise customers. For example, a service provider such as a telecom carrier stores telecommunications information associated with its enterprise customers. However, one skilled in the art will recognize that the unified shared business application system 100 may be implemented in other types of markets, such as the automobile industry, finance, food, drug, among others, and the information stored in the virtual data warehouse 190 would reflect these types of markets and the customers the service provider serves.

In one embodiment, the DBOR Infrastructure technology is based on more flexible and industry standard Java 2 Enterprise Edition (J2EE), Java Message Service (JMS) and reusable Enterprise Java Beans (EJB's) for transactional unit requests or real-time bulk loading using Extract, Transform and Load (ETL) technologies. ETL tools provide a quick connectivity to all relational database based back-end systems, can extract their Metadata, and build relationships across multiple databases with minimal human intervention.

Referring to FIG. 5, the DBOR infrastructure further comprises a plurality of adaptors 506 a JMS layer 508, a context layer (EJB) comprising a plurality of business function objects 512, a data access and transformation layer 516, a DBOR layer 520, a client contact view layer 530, an API layer 540, and a client presentation layer 542. The DBOR Infrastructure 190 receives a data request from a client application 151. The client application 151 passes a predefined set of parameters associated with the user. Such predefined set of parameters illustratively include user preferences, restrictions, and the like, as discussed above with regard to the DENS application 242 of FIGS. 2 and 3.

The request is analyzed and passed to the next state to be decomposed referring to the client transformation rules engine. Furthermore enough parameters are held, which maintain state while the request is being processed by the infrastructure. The breakdown of the request post transformation is related to a set of predefined contexts 512 in the infrastructure. For example, the predefined contexts may include customer, location, circuit, PVC, port, ISG, dial plan, dial number, and the like. These contexts are invoked and recognized. The context attributes are also identified which kicks-off a request creation process to back-end systems. Based on scenario, the request may have one or more target back-end systems. All back-end requests with the same state will be triggered parallel by the infrastructure. Adapter 506 illustratively include CORBA, SPC, and the like the JMS layer adaptors 508 illustratively include MQ-series, JMS, and the like, while the API layer adaptors 540 illustratively include HMG, CORBA, JCA, GCMP/HTTP, and the like. The adaptor components 506, 508, and 540 of the infrastructure 190 perform any transformation and data mapping functions need to communicate with the back-end systems.

The infrastructure 190 interprets and decomposes the demand application client request based on data access and transformation rules 516. The infrastructure 190 carries enough intelligence to make a decision as to which sources the data belongs in the back-end 504. Depending on the need, the infrastructure then initiates single or multiple parallel requests for data from single or multiple back-end systems. Data from the backend databases 504 is aggregated, scrubbed, and transformed before supplying to the requesting client. Aggregation 522, scrubbing 524, and transformation 536 rules in the infrastructure 190 provide details on how and what data elements need to be assembled in the infrastructure. Client customisation rules 532 and 534 finalize the details of the response to the calling demand application client.

The virtual data warehouse (DBOR) 190 is functionally similar to a traditional data warehouse, which has access to large amounts of Customer and Business data. The virtual data warehouse provides aggregated views of the inventory, contains metadata, and is based on the carrier data model, which defines how to store enterprise information. The Extract, Transform and Load (ETL) tools provide a quick connectivity to all relational database based back-end systems 504, can extract their metadata, and build relationships across multiple databases with minimal human intervention. Capabilities to connect to data extracts and perform automated data analysis using the ETL toolset quickly resolves the complexities associated with the analysis of Legacy mainframes based databases. The result is that all the manual work historically associated with realizing the data warehouses is virtually minimized. This metadata is used in deriving the logical enterprise data model 110 and is also used in modelling the EJB's 510 for the transactional segment, thus increasing the reuse and reducing cost and timeframe to deploy.

This architecture eliminates all complexities of physical movement of data reducing capital costs associated with warehousing, development and maintenance. The virtual data warehouse 190 can grow incrementally as the back-end systems 504 are published in time and their metadata is extracted, which contributes to the derivation of the enterprise data model 110.

The DBOR infrastructure 190 is flexible compared to a traditional data warehouse as the design eliminates movement of data physically from the back-end source systems 504 to a staging database. Instead, the virtual data warehouse 190 provides different business views including customer, finance, networking, service, data entity, and data metrics extracting data just in time. Business aspect benefits lie in the capabilities the data warehouse 190 provides, which do not force the legacy back-end systems to change. To virtually reduce the data warehousing costs to negligible amounts, the design takes advantage of already deployed redundant or secondary instances of the back-end systems, and uses them as the and when data is requested by calling demand applications.

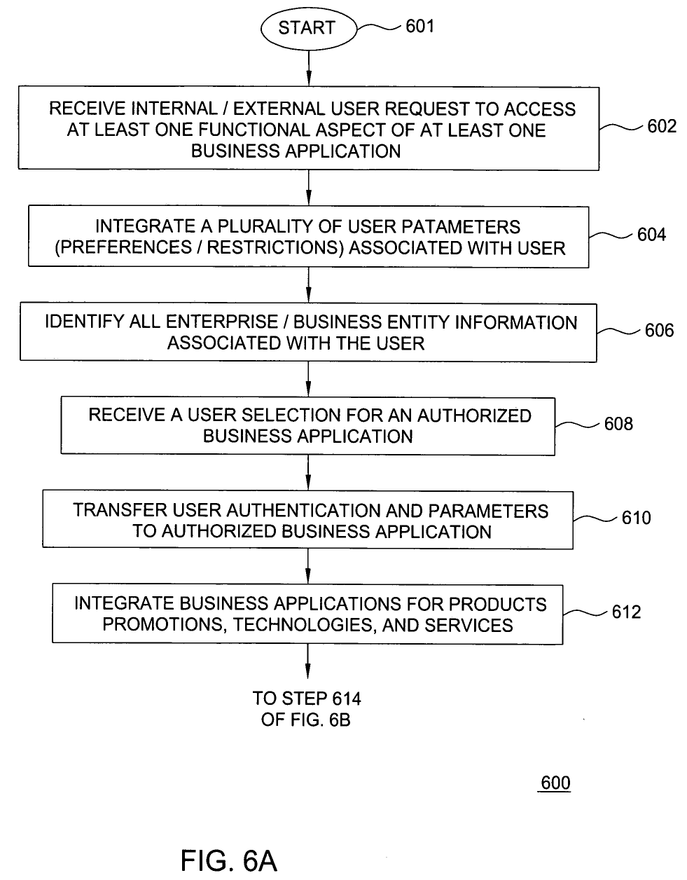

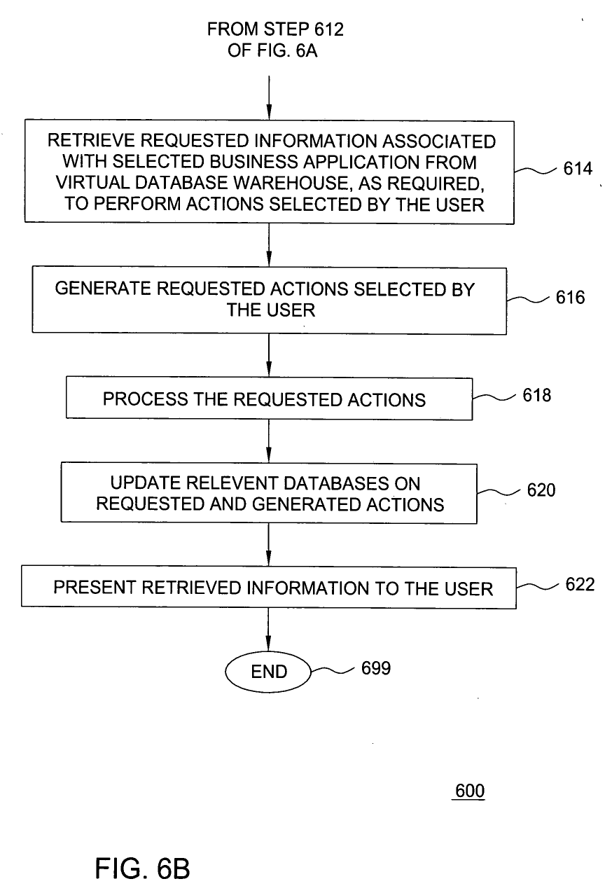

FIGS. 6A and 6B collectively depict a flow diagram of a method 600 for retrieving information associated with functional aspects of a business operation in accordance with the present invention. Referring to FIG. 6A, the method 600 starts at step 601, where a user of the present invention wishes to acquire information regarding one or more business processes pertaining to the business entity the user is associated. For example, the user may be associated with a customer channel, sales channel, among other channels of the telecommunications service provider. To acquire such information, the user accesses an access point, such as a web page or telephone voice tone service. The method 600 then proceeds to step 602.

At step 602, the unified portal 104 facilitating the access point receives the user request to access at least one functional aspect of at least one business application 151 (e.g., a customer ordering services). Specifically, the user logs into the unified portal 104, illustratively, at the website by providing at least one of a user name, identification, password, and the like. The portal serves as a host that allows other applications to be run, such as DENS, IOM, e-map, among others.

At step 604, the authentication information is sent to the DENS application 242, where the DENS application 242 integrates a plurality of user parameters associated with the user. In particular, the DENS application 242 utilizes the login information to retrieve the user's user profile to access information associated with all of the business processes 151 for a particular enterprise. That is, the user identification is used by the enterprise function (CCI) to associate the user with a corresponding enterprise. For purposes of understanding the invention, it is assumed that the user profile has already been created and updated during previous user sessions.

At step 606, the unified portal 104 tasks the enterprise function (i.e., CCI) 102 to identify all enterprise/business entity information associated with the user. Specifically, the CCI value is identified in the CCI database to determine what enterprise the user is associated with, and the information privileges (i.e., access) such user has within the enterprise. For example, if the user employed by a division of General Electric (GE) Corporation (e.g., GE Industrial Systems) seeks to acquire information relevant to his/her duties as an employee, the portal 104 initiates the enterprise function 102 to identify all information pertaining to the enterprise, General Electric Corporation. That is, the enterprise function 102 identifies other divisions and subsidiaries of GE Corp., such as GE Transportation, GE Finance, GE Medical Systems, among the many other divisions/subsidiaries associated with General Electric Corporation. In other words, at step 606, the method 600 identifies everything associated with the individual GE subsidiaries/divisions in the databases. More specifically, the CCI database 194 returns all of the MCNs for the related account, and the MCNS are used to get the data from the data warehouse for each of the subsidiaries, divisions, and enterprise accounts. At this time, the portal function 104 has now authenticated, and identified the preferences and restrictions (i.e., user parameters) associated with the user, and waits for a business application selection from the user.

At step 608, the portal function 104 receives a user selection for an authorized business application 151. For example, the user may be a sales representative in the sales channel 134 who is placing an order for services for one of the carrier's customers. Alternatively, the user may be a field engineer performing maintenance or repair for a service of a particular customer. Such sales rep or field engineer may wish to utilize a portal hosted application such as IOM, e-match, e-map, among others. In any case, once the user has selected a particular business application 151, at step 610, the portal function 104 transfers the user authentication and parameters to the authorized business application 151 (e.g., the ordering application 152 or maintenance application 156). It is noted that in the event the user selects a non-authorized business application, the user is automatically denied entry, and is notified of making a non-authorized business application selection. The method 600 then proceeds to step 612.

At step 612, the business applications receive the user selection and associated authentications and parameters to integrate various to products, promotions, technologies, services, and the like associated with the user selection. For example, if a user selects the maintenance function to generate a trouble ticket for a particular product, the business applications function 151 integrates all information associated with generating a trouble ticket, such as upgrade information, product information, technological information, and any other information related to the user selection.

At step 614, the selected business application retrieves the requested information (as well as any collateral information associated with the requested information) from the virtual database warehouse 190, as required, to subsequently perform actions associated by the user request. Specifically, the application utilizes the MCNs to identify related information in the database warehouses 190. At step 616, the selected business function generates the requested action or actions selected by the user. For example, if a trouble ticket is requested, the maintenance application 156 illustratively generates a trouble ticket, initiates notices to be sent out, generate maintenance reports, among generating any other maintenance related events.

Furthermore, other business applications may generate various actions in response to the selected action by the user. For example, the provisioning application 154 or some other business applications may be impacted by the user selecting a maintenance action, such as the issuance of a trouble ticket for a particular product, and accordingly, responds in a similar manner as the selected business application (i.e., the maintenance action). The method 600 then proceeds to step 618.

At step 618, the integrated business applications 150 process the requested actions. For example, the maintenance application issues the trouble ticket, sends the notices, and the like. Furthermore, the other business applications respond to the maintenance action as required. At step 620, the databases, i.e., the virtual database warehouse 190 is updated based on the requested and generated actions.

For example, the DBOR 108 store information pertaining to the issuance of a trouble ticket and any associated information necessary to maintain a current status of the customer's relationship with the carrier. For example, information associated with the issuance of a trouble ticket may include date and time of occurrence, network alarms, customer spare part inventory levels, among other customer and carrier related information.

At step 622 the retrieved information is presented to the user at the portal 104. Accordingly, the user may take another action associated with the previous action, receive status, or any take any other action within the authorization of the user. The method 600 then proceeds to step 699 where the method 600 ends.

The unified shared system 100 of the present invention enables a service provider, such as a telecommunications service provider, to combine various web sites and their supporting linkages, such as back-office processes, security, and authorization, into a single unified platform, which provides consistency and coordination in service delivery on a cross-service basis for its users associated with various channels. The unified shared system 200 improves service quality by ensuring data integrity in an enterprise-wide database architecture. Specifically, the single access point (e.g., web portal) replaces a silo view of the prior art service provider's ad hoc offerings, and instead provides a comprehensive view that spans all of the service providers delivery mechanisms, from wireless to the Web, to XML.

The single view, via the access point of the present invention, simplifies the users' interactions with the service provider, while eliminating duplication of work and improving synergies throughout the enterprise. Specifically, the unified shared system 100, with its web portal, allows the carriers business customers, ranging from small family-run operations to global enterprises, to place orders, check order status, pay bills, report and track service problems, test circuits, reroute network traffic in real time, and manage other customer related service tasks. Accordingly, the user is provided with a novel tool that increases the efficiency of interacting with the databases of the service provider, which translates into greater productivity as well as cost savings for the user and enterprises/business entities utilizing the unified shared system of the present invention.

It is noted that the present invention may be implemented using one or more general purpose computing devices. In one embodiment, general purpose computing device comprises a processor, a memory for storing programs, data and the like, support circuits, and Input/Output (I/O) circuits, as conventionally known in the art. The processor operates with conventional support circuitry such as power supplies, clock circuits, and the like. Additionally, the processor also operates with a plurality of I/O circuits or devices such as a keyboard, a mouse, a monitor, a storage device such as a disk drive and/or optical drive and the like. In one embodiment, the present apparatus and method for monitoring event occurrences can be adapted as a software application that is retrieved from a storage device that is loaded into the memory and is then executed by the processor.

As such, it is contemplated that some and/or all of the steps of the above methods and data structure as discussed above can be stored on a computer-readable medium. Alternatively, the present apparatus for monitoring event occurrences can be implemented, in part or in whole, in hardware, for example, as an application specific integrated circuit (ASIC). As such, the process steps described herein are intended to be broadly interpreted as being equivalently performed by software, hardware, or a combination thereof. For example, such general purpose computers may be implemented in the computer devices 216, 230, 232, 234, 236, 238, and 242 of FIG. 2, as well as general purpose computers that integrate the enterprise 110, portal 104, business applications 150, and data warehousing 190 functions of the present invention.

While the foregoing is directed to embodiments of the present invention, other and further embodiments of the invention may be devised without departing from the basic scope thereof, and the scope thereof is determined by the claims that follow.

1. A unified shared business application system, comprising:
a unified portal for authenticating and authorizing user preferences and restrictions;
an enterprise function, for providing a common customer identifier (CCI) for users associated with a plurality of business channels of a plurality of enterprises, wherein said enterprise function associates a CCI associated with each enterprise to each user accessing said unified portal;
an integrated business applications system for integrating a plurality of business applications across products and services, said integrated business applications being responsive to authorized user selections of at least one business application from said unified portal; and
a database warehouse for storing information associated with said business channels of said plurality of enterprises, each user, and said products and services.

2. The unified shared business application system of claim 1, wherein said enterprise function associates a plurality of sub-enterprise entities associated with said user.

3. The unified shared business application system of claim 1, wherein said plurality of business channels comprise at least one of a customer channel, a sales channel, an alliances channel, and an internal operations channel.

4. The unified shared business application system of claim 1, wherein said plurality of business applications comprises an ordering application, a maintenance application, and a billing application.

5. The unified shared business application system of claim 1, wherein each of said plurality of business applications are integrated across products and technologies associated with said users of said business channels.

6. The unified shared business application system of claim 1, wherein said database warehouse comprises a virtual unified database and is updated based on actions taken by said plurality of business applications in response to said user selections.

7. The unified shared business application system of claim 1, wherein said CCI is associated with at least one master customer number (MCN), where each of said MCNs is associated with a business sub-entity of said enterprise.

8. The unified shared business application system of claim 7, wherein said plurality of business applications utilize said MCN to retrieve information from said database warehouse.

9. The unified shared business application system of claim 1, wherein said unified portal is a host for accessing said plurality of business applications.

10. The unified shared business application system of claim 1, wherein said CCI is utilized to associate a user with an enterprise, and provide indicia of priority for servicing an enterprise customer.

11. The unified shared business application system of claim 1, wherein said unified portal comprises and interface for providing graphical and textual information.

12. A method of unifying and sharing business applications with respect to a user of a business channel, comprising:
authenticating and authorizing, at a unified portal, user preferences and restrictions in response to a user request for access;
providing, at an enterprise function, a common customer identifier (CCI) for users associated with a plurality of business channels of an enterprise, wherein said enterprise function associates a CCI to each user accessing said unified portal;
integrating, in response to a user selection of a business application, information associated across a plurality of business applications with respect to products and services, said integrated business applications being responsive to authorized user selections of at least one business application from said unified portal; and
storing, at a database warehouse, information associated with said business channels, each user, and said products and services.

13. The method of claim 12, wherein said providing at said enterprise function further comprises associating a plurality of sub-enterprise entities associated with said user.

14. The method of claim 12, wherein said providing a CCI for users associated with said function said plurality of business channels comprises providing a CCI for users of at least one of a customer channel, a sales channel, an alliances channel, and an internal operations channel.

15. The method of claim 12, wherein said integrating step comprises integrating information associated with an ordering application, a maintenance application, and a billing application with respect to said user selection.

16. The method of claim 12, wherein said integrating step further comprises integrating said plurality of business applications across products and technologies associated with said users of said business channels.

17. The method of claim 12, wherein said storing information at a database warehouse further comprises updating said information based on actions taken by said plurality of business applications in response to said user selections.

18. The method of claim 12, wherein said providing, at an enterprise function, a common customer identifier (CCI) for users associated with a plurality of business channels further comprises associating said with at least one master customer number (MCN), where each of said MCNs is associated with a business sub-entity of said enterprise.

19. The method of claim 18, further comprising utilizing said MCNs associated with said business applications to retrieve information from said database warehouse.

20. The method of claim 12, wherein said authenticating and authorizing at said unified portal further comprises selectively permitting accessing to said plurality of business applications.

21. The method of claim 12, further comprising utilizing said CCI to associate a user with an enterprise, and provide indicia of priority for servicing an enterprise customer.

22. The method of claim 12, wherein said unified portal comprises providing a user interface for displaying graphical and textual information.
